(19) United States
(12) Patent Application Publication
(10) Pub. No.: US 2025/0230958 A1
(43) Pub. Date: Jul. 17, 2025

(54) REVERSING VALVE WITH INTEGRATED HEAT EXCHANGER AND BYPASS

(71) Applicant: Haier US Appliance Solutions, Inc., Wilmington, DE (US)

(72) Inventor: Bryan Isaac D’Souza, Louisville, KY (US)

(21) Appl. No.: 18/413,880

(22) Filed: Jan. 16, 2024

(51) Int. Cl. F25B 41/26; F16K 11/065; F25B 13/00

(52) U.S. Cl. CPC F25B 41/26; F16K 11/0655; F25B 13/00; F25B 2313/02741

(57) ABSTRACT

A reversible heat pump refrigeration system comprises a refrigeration loop with an outdoor heat exchanger, an indoor heat exchanger, and a valve body fluidly coupled to the refrigeration loop. The valve body comprises a valve inlet and a valve outlet, the valve outlet includes a heat exchanger, the valve body fluidly coupled to the suction side of a compressor.

### FIELD OF THE INVENTION

The present disclosure relates generally to four-way or reversing valves. In particular, the present disclosure is directed to a reversing valve with an integrated heat exchanger.

### BACKGROUND OF THE INVENTION

Reversible heat pump refrigeration systems may be used to alternately provide heating and cooling to a conditioned space with an indoor heat exchanger and an outdoor heat exchanger fluidly coupled to a refrigeration loop. A reversing valve, sometimes known as a four-way valve, may be used to direct a flow of a refrigerant in a first direction to provide a cooling mode, and to direct the flow in a second direction to provide a heating mode.

In some cases, the performance of a reversible heat pump refrigeration system in one mode may be less efficient than the system in the other mode. The inefficiencies may be related to the characteristics of the refrigerant functioning less efficiently in one mode than in the other. Additionally or alternatively, one or more elements in the refrigeration loop may be less efficient in one mode than in the other mode. For example, the heat transfer process at the indoor heat exchanger in the cooling mode (as an evaporator) may be more efficient than the heat transfer process at the indoor heat exchanger in the heating mode (as the condenser). Further, components included to improve efficiency in one mode may negatively impact the efficiency in the other mode. In this regard, bypassing one or more components, or a portion of one or more components, of a reversible heat pump refrigeration system may be beneficial to the efficiency of a mode of operation. In some cases, the improved efficiency in one mode may beneficially influence the overall efficiency of the refrigeration system.

Accordingly, a reversible heat pump refrigeration system including a bypass when operated in one mode may be beneficial.

### BRIEF DESCRIPTION OF THE INVENTION

Aspects and advantages of the invention will be set forth in part in the following description, may be apparent from the description, or may be learned through practice of the invention.

In one exemplary aspect, a reversible heat pump refrigeration system is presented. The system comprises a refrigeration loop comprising an outdoor heat exchanger and an indoor heat exchanger and a valve body fluidly coupled to the refrigeration loop. The valve body comprises a valve inlet, a valve outlet, a first port, a second port, and a shuttle selectively movable in the valve body between a first position and a second position. The system further comprises a compressor having a suction side fluidly coupled to the valve outlet and a pressure side fluidly coupled to the valve inlet wherein the valve outlet includes a heat exchanger having a first connection and a second connection.

In another exemplary aspect, a reversing valve assembly comprises a valve body comprising a valve inlet and a valve outlet, a first port and a second port, and a shuttle selectively movable in the valve body between a first position and a second position. The valve outlet includes a heat exchanger having a first connection and a second connection.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic illustration of an air conditioning including an exemplary reversible heat pump refrigeration system in accordance with an embodiment of this disclosure;

FIG. 2 provides a schematic illustration of an exemplary reversible heat pump refrigeration system in accordance with an embodiment of this disclosure;

FIG. 3 provides a sectional view of a reversing valve assembly illustrating the valve in a first position in accordance with an embodiment of this disclosure;

FIG. 4 provides a sectional view of a reversing valve assembly illustrating the valve in a second position in accordance with an embodiment of this disclosure; and

FIG. 5 provides a representative refrigeration loop in representative pressure-enthaply chart in accordance with an embodiment of the present invention.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

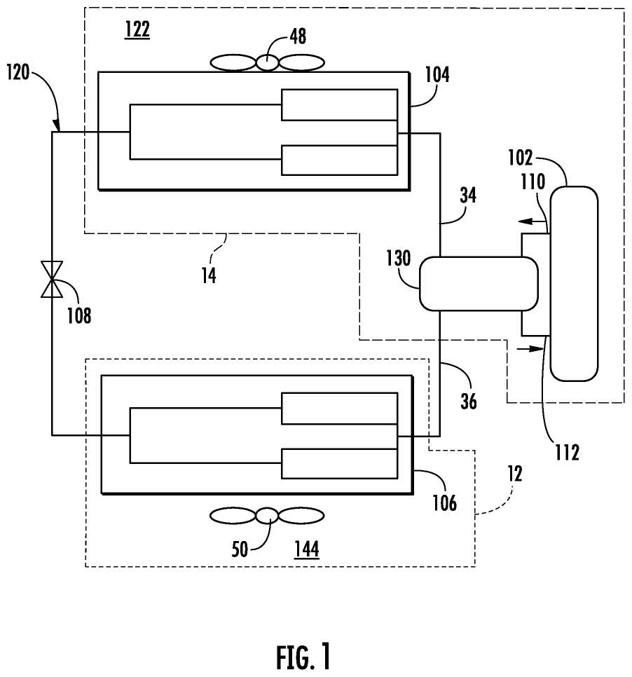

Turning to the figures, FIG. 1 provides a perspective view of an air conditioner 100 including an exemplary reversible heat pump refrigeration system according to an embodiment of the present subject matter. As discussed in greater detail below, air conditioner 100 includes a refrigeration loop 120 comprising compressor 102, an outdoor heat exchanger 104, an indoor heat exchanger 106, and an expansion device 108 fluidly coupled together to form a refrigeration loop 120. Thus, air conditioner 100 may be a self-contained system for heating and/or cooling air.

With reference to FIG. 1, air conditioner 100 includes an indoor module 12, and an outdoor module 14. Indoor module 12 and outdoor module 14 are spaced apart from each other, e.g., with an internal bulkhead. Thus, when installed e.g., through an exterior wall, indoor module 12 may be positioned at or contiguous with a space to be conditioned, conditioned space 144, and outdoor module 14 may be positioned at or contiguous with an outdoor environment 122.

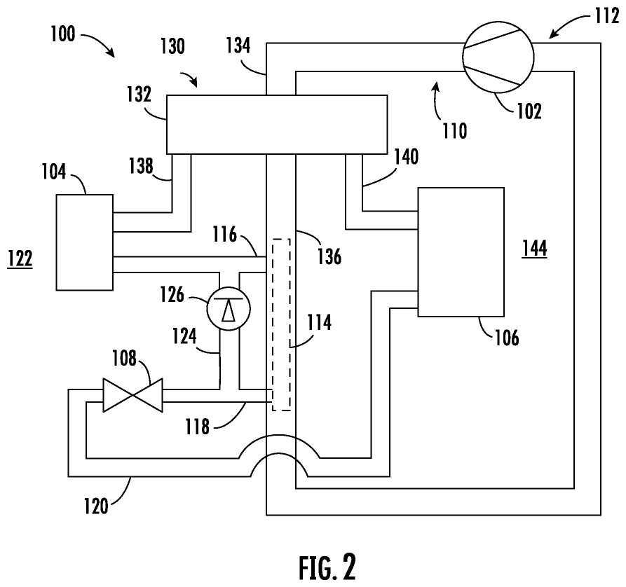

Referring to FIGS. 1 and 2, sealed system 120 is disposed or positioned within air conditioner 100, and sealed system 120 includes components for transferring heat between the outside environment 122 and the conditioned space 144. In particular, various components of sealed system 120 are positioned within indoor module 12 while other components of sealed system 120 are positioned within outdoor module 14.

Air conditioner 100 further includes a controller (not shown) with user inputs, such as buttons, switches and/or dials. The controller regulates operation of air conditioner 100. Thus, the controller is in operative communication with various components of air conditioner 100, such as components of sealed system 120 and/or a temperature sensor (not shown), such as a thermistor or thermocouple, for measuring the temperature of the conditioned space 144. In particular, the controller may selectively activate sealed system 120 in order to chill or heat air within conditioned space 144, e.g., in response to temperature measurements from the temperature sensor.

The controller includes memory and one or more processing devices such as microprocessors, CPUs or the like, such as general or special purpose microprocessors operable to execute programming instructions or micro-control code associated with operation of air conditioner 100. The memory can represent random access memory such as DRAM, or read only memory such as ROM or FLASH. The processor executes programming instructions stored in the memory. The memory can be a separate component from the processor or can be included onboard within the processor. Alternatively, the controller may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Sealed system 120, represented schematically in FIGS. 1 and 2, generally operates in a heat pump cycle. Sealed system 120 includes a compressor 102, an indoor heat exchanger 106 and an outdoor heat exchanger 104. As is generally understood, various conduits (e.g., 34, and extension of first port 138 or 36, an extension of second port 140, both shown in FIG. 2) may be utilized to flow refrigerant between the various components of sealed system 120. Thus, e.g., indoor heat exchanger 106 and outdoor heat exchanger 104 may be in fluid communication with each other and compressor 102. In general, indoor module 12 and outdoor module 14 may be in fluid communication with each other via various conduits (e.g., 34, or 36).

As may be seen in FIGS. 1 and 2, sealed system 120 also includes a reversing valve assembly 130. Reversing valve assembly 130 selectively directs compressed refrigerant from compressor 102 to either indoor heat exchanger 106 via conduit 36 or to outdoor heat exchanger 104 via conduit 34. For example, in a cooling mode, reversing valve assembly 130 is arranged or configured to direct compressed refrigerant from compressor 102 to outdoor coil 104. In the cooling mode, outdoor heat exchanger 104 is a condenser and indoor heat exchanger 106 is an evaporator. Conversely, in a heating mode, reversing valve assembly 130 is arranged or configured to direct compressed refrigerant from compressor 102 to indoor heat exchanger 106. Consequently, in the heating mode, indoor heat exchanger 106 is a condenser and outdoor heat exchanger 104 is the evaporator. Thus, reversing valve assembly 130 permits refrigeration loop 120 to adjust between the heating mode and the cooling mode, as will be understood by those skilled in the art.

During operation of sealed system 120 in the cooling mode, refrigerant flows from indoor heat exchanger 106 through compressor 102. For example, refrigerant may exit indoor heat exchanger 106 as a fluid in the form of a superheated vapor. Upon exiting indoor heat exchanger 106, the refrigerant may enter compressor 102. Compressor 102 is operable to compress the refrigerant. Accordingly, the pressure and temperature of the refrigerant may be increased in compressor 102 such that the refrigerant becomes a more superheated vapor.

Outdoor heat exchanger 104 is disposed downstream of compressor 102 in the cooling mode and acts as a condenser. Thus, outdoor heat exchanger 104 is operable to reject heat into the outside environment 122 at outdoor module 114 of air conditioner 100 when sealed system 120 is operating in the cooling mode. For example, the superheated vapor from compressor 102 may enter outdoor heat exchanger 104 via a first distribution conduit 34 that extends between and fluidly connects reversing valve assembly 130 and outdoor heat exchanger 104. Within outdoor heat exchanger 104, the refrigerant from compressor 102 transfers heat energy to the outdoor atmosphere and condenses into a saturated liquid and/or liquid vapor mixture. An outdoor fan 48 may be positioned adjacent outdoor heat exchanger 104 and may facilitate or urge a flow of air from the outside environment across outdoor heat exchanger 104 in order to facilitate heat transfer.

Sealed system 120 also includes a expansion device 108 disposed between indoor heat exchanger 106 and outdoor heat exchanger 104, e.g., such that expansion device 108 extends between and fluidly couples indoor heat exchanger 106 and outdoor heat exchanger 104. Refrigerant, which may be in the form of high liquid quality/saturated liquid vapor mixture, may exit outdoor heat exchanger 104 and travel through expansion device 108 before flowing through indoor heat exchanger 106. Expansion device 108 may generally expand the refrigerant, lowering the pressure and temperature thereof. The refrigerant may then be flowed through indoor heat exchanger 106.

Indoor heat exchanger 106 is disposed downstream of expansion device 108 in the cooling mode and acts as an evaporator. For example, the liquid or liquid vapor mixture refrigerant from outdoor heat exchanger 104 may enter indoor heat exchanger 106 via expansion device 108 that extends between and fluidly connects indoor heat exchanger 106 and outdoor heat exchanger 104. Thus, indoor heat exchanger 106 is operable to heat refrigerant within indoor heat exchanger 106 with energy from the conditioned space 144 at indoor module 112 of air conditioner 100 when sealed system 120 is operating in the cooling mode. Within indoor heat exchanger 106, the refrigerant from expansion device 108 receives energy from the indoor atmosphere 104 and vaporizes into a superheated vapor and/or high quality vapor mixture. An indoor fan 50 is positioned adjacent indoor heat exchanger 106 and may facilitate or urge a flow of air from the conditioned space 144 across indoor heat exchanger 106 in order to facilitate heat transfer. Indoor fan 150 may be any suitable fan configured to provide a required air flow to achieve the required heat transfer, for example, indoor fan 150 may be a cross-flow fan.

During operation of sealed system 120 in the heating mode, reversing valve assembly 130 reverses the direction of refrigerant flow through sealed system 120. Thus, in the heating mode, indoor heat exchanger 106 is disposed downstream of compressor 102 and acts as a condenser, e.g., such that indoor heat exchanger 106 is operable to reject heat into the conditioned space 144 at indoor module 112 of air conditioner 100. In addition, outdoor heat exchanger 104 is disposed downstream of expansion device 108 in the heating mode and acts as an evaporator, e.g., such that outdoor heat exchanger 104 is operable to heat refrigerant within outdoor heat exchanger 104 with energy from the exterior atmosphere at outdoor module 114 of air conditioner 100.

Indoor coil 106 and indoor fan 50 may be positioned within indoor module 112. Conversely, compressor 102, outdoor heat exchanger 104, reversing valve assembly 130 and outdoor fan 48 may be positioned within outdoor module 114. In such a manner, certain noisy components of sealed system 120 may be spaced from the interior atmosphere 104, and air conditioner 100 may operate quietly. Various fluid passages, such as refrigerant conduits, liquid runoff conduits, etc., may fluidly connect components within indoor and outdoor modules 112, 114.

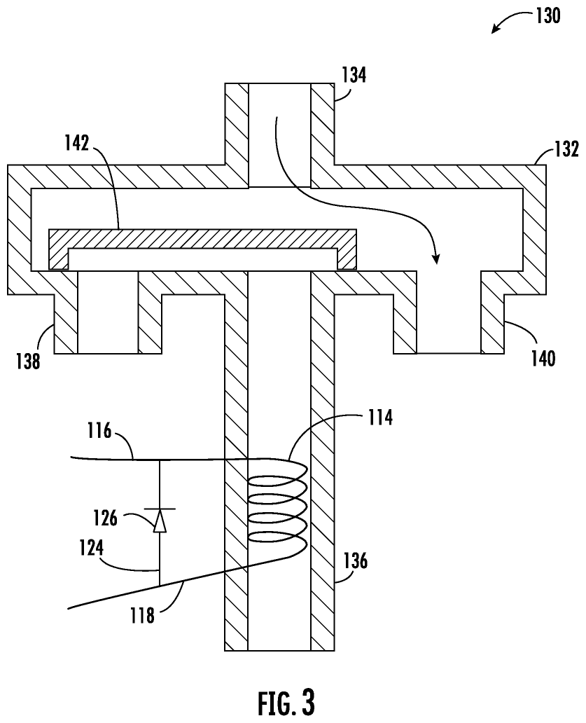

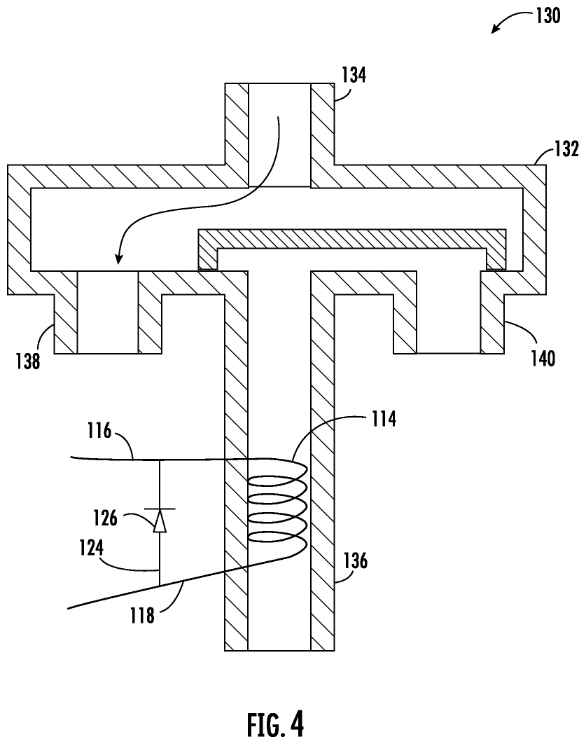

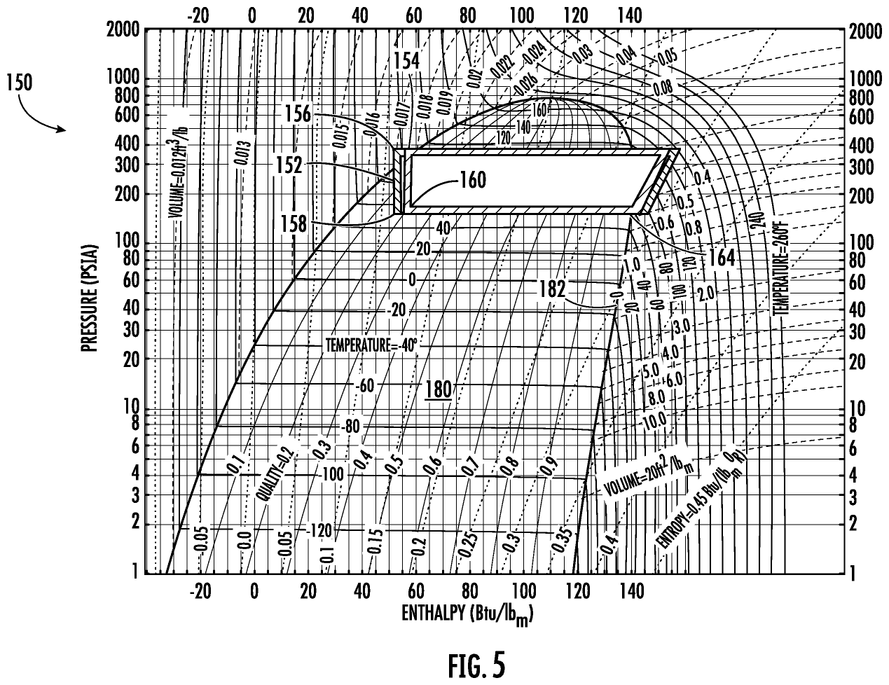

FIG. 2 provides a schematic illustration of an exemplary reversible heat pump refrigeration system, system 100. FIGS. 3 and 4 are sectional views of the reversing valve assembly 130 illustrating the shuttle 142 in a first position and a second position, respectively. FIG. 5 provides a chart showing the thermodynamic properties of a representative refrigerant through each component of a representative heat loop. As illustrated, system 100 comprises a compressor 102, an outdoor heat exchanger 104, an indoor heat exchanger 106, and an expansion device 108 fluidly coupled together to form a refrigeration loop 120. The compressor 102 urges the flow of a working fluid, generally a refrigerant, through the components of the refrigeration loop 120 by drawing in a lower pressure working fluid at the suction side 112 and pressurizing the refrigerant at the discharge side 110. The compressor 102 may be any type of conventional compressor (for example a reciprocating, scroll, helical-rotary (i.e., screw), or centrifugal compressor) suitable to pressurize the refrigerant, and is therefore not described in detail.

As illustrated, the pressure side 110 is fluidly coupled to a reversing valve assembly 130 comprising valve body 132, valve inlet 134, valve outlet 136, first port 138, and second port 140. A shuttle 142 is included inside the valve body 132, the shuttle selectively movable between a first position (FIG. 3) and a second position (FIG. 4) under the operation of a solenoid valve (not shown) controlled by a controller (not shown). As shown in FIG. 3, in the first position, shuttle 142 fluidly couples the first port 138 with the valve outlet 136 and fluidly couples valve inlet 134 with the second port 140. Alternately, in the second position (FIG. 4), the shuttle 142 fluidly couples the second port 140 with the valve outlet 136 and fluidly couples the valve inlet 134 with the first port 138.

Accordingly, in the first position (FIG. 3), the reversing valve assembly 130 directs relatively warm compressed refrigerant to the indoor heat exchanger 106 where the heat may be rejected to the conditioned indoor space 144, i.e., in a heat pump mode. Alternately, in the second position (FIG. 4) the reversing valve assembly 130 directs relatively warm compressed refrigerant to the outdoor heat exchanger 104 where heat is rejected to the outside environment 122, i.e., in a cooling mode.

Continuing with the cooling mode discussed above, in the exemplary embodiment of FIG. 2 with the reversing valve assembly 130 in the second position of FIG. 4, the compressed and relatively warm refrigerant leaves the discharge side 110 of the compressor 102, enters the valve body 132 at the valve inlet 134 and exits the valve body through first port 138 to the outdoor heat exchanger 104. After travelling through the outdoor heat exchanger 104, the refrigerant enters an in-line heat exchanger, heat exchanger 114, located within the valve outlet 136, at heat exchanger entrance or first connection 116.

The heat exchanger 114 may be any suitable type, for example a shell and coil or tube-in-tube heat exchanger. The refrigerant exits the heat exchanger 114 at heat exchanger exit or second connection 118. The relationship of heat exchanger first and second connection 116, 118 within the valve outlet 136 is illustrative and chosen for ease of illustration. As illustrated, first connection 116 is upstream of second connection 118. In other words, the flow of refrigerant in the valve outlet 136 is from heat exchanger first connection 116 towards heat exchanger second connection 118, i.e. the flow direction in the heat exchanger 114 is in the same direction as the flow in the valve outlet 136. In other embodiments, the relative position of first connection 116 with regard to second connection 118 may be reversed. In other embodiments, the heat exchanger entrance and exit, first connection 116 and second connection 118, may be proximate to each other. Passing refrigerant through the in-line heart exchanger 114 further cools the refrigerant prior to entering the expansion device 108 and the indoor heat exchanger 106.

After leaving the in-line heat exchanger 114, the refrigerant flows to expansion device 108. According to the exemplary embodiment, expansion device 108 may be an electronic expansion valve (“EEV”) that enables controlled expansion of refrigerant, as is known in the art. The EEV is controlled by a controller (not shown) to throttle the flow of refrigerant based on operating parameters and performance of other components of the refrigeration loop 120. According to alternative embodiments, expansion device 108 may be a capillary tube or another suitable expansion device configured for use in a thermodynamic cycle.

In the illustrated cooling mode, the expanded and relatively cool refrigerant flows to the indoor heat exchanger 106 where it absorbs heat from the conditioned space 144 to cool the conditioned space 144. For example, an indoor fan may urge a flow of indoor air across the indoor heat exchanger 106 and into the space to provide a flow of cooled air within the conditioned space 144. After flowing through the indoor heat exchanger 106, the warmer refrigerant flows into the reversing valve assembly 130 at second port 140.

Continuing with the above example, the reversing valve assembly 130 is in the second position represented in FIG. 4, corresponding to the cooling mode for the reversible heat pump refrigeration system 100. With the shuttle 142 in the second position, the valve outlet 136 is fluidly coupled with the second port 140. The relatively warmer refrigerant from the indoor heat exchanger 106 flows into the second port 140 and is directed to the valve outlet 136.

According to an embodiment, the valve outlet 136 includes a heat exchanger 114 positioned such that the flow of refrigerant in the valve outlet 136 flows over or through the heat exchanging features (e.g., coils, fins, or plates) of the heat exchanger 114, facilitating heat transfer from the refrigerant leaving the outdoor heat exchanger 104. As above, the heat exchanger 114 may be any suitable type, for example a shell and coil or tube-in-tube heat exchanger. In the cooling mode illustrated, the refrigerant flowing from the heat exchanger first connection 116 to the heat exchanger second connection 118 is generally warmer than the refrigerant flowing in the valve outlet 136. Accordingly, heat is transferred from the heat exchanger 114 to the refrigerant flow in the valve outlet 136.

The effects of the heat exchanger 114 on the refrigerant and the thermodynamic process may be illustrated in FIG. 5, a representative pressure-enthalpy chart for a typical refrigerant. The numerical values on the pressure-enthalpy chart are for reference only and provided to illustrate an exemplary process. The vertical line 152 represents liquid refrigerant flowing through the expansion device 108. At 154, the refrigerant properties are representative of the refrigerant at first connection 116, prior to entering the in-line heat exchanger 114. The horizontal line between 154 and 156 represents the effect of the in-line heat exchanger on the refrigerant. According to an embodiment of the present disclosure, 156 is illustrative of characteristics of the refrigerant at second connection 118 after flowing through the in-line heat exchanger 114. As will be understood by one of ordinary skill in the art, the refrigerant conditions at 156 represent a cooler, or slightly cooler, liquid with a lower enthalpy than the refrigerant at 154.

As the refrigerant flows through the expansion device 108, the refrigerant changes state from a liquid to a mixed phase of liquid and vapor while enthalpy substantially remains constant (isenthalpic process) as is generally understood. By passing through the in-line heat exchanger 114 prior to the expansion device 114, the refrigerant, according to a present embodiment, is cooler with a lower enthalpy than a refrigerant that did not pass through heat exchanger 114 (represented by 160). The lower temperature and enthalpy at 158 compared to 156 may be beneficial to the heat exchange process at the indoor heat exchanger 106.

Horizontal line 162 represents the flow of mixed phase refrigerant flowing through the indoor heat exchanger 106. The area enclosed by dome bordered by 182 is understood to be the mixed phase region 180 of the refrigerant represented by chart 150. In the mixed phase or two-phase region 180, two-phase heat exchange occurs between the mixed phase refrigerant in the indoor heat exchanger 106 and the indoor air flowing over or through the evaporator (for example air urged by an indoor fan). Accordingly, in the present illustrative embodiment, two-phase heat exchange occurs from 158 to 164, with 164 representing the intersection of line 162 and the limit of the two-phase region 180, indicated by 182. Outside of the dome bordered by 182, the representative refrigerant exists in a single phase. In general, refrigerant to the right of dome 182 is vapor and to the left is liquid. It is generally understood that two-phase heat exchange is more efficient than single phase heat exchange. In a two-phase state, a heat transfer fluid (here, a refrigerant) absorbs heat without changing temperature. The absorbed energy converts the liquid phase to vapor with no temperature change to either phase. As fluid heat transfer is influenced by temperature differential between the fluids, maintaining one fluid at a constant temperature during a heat transfer process produces a larger temperature differential between the fluids than if both fluids approached the same temperature. Accordingly, maintaining a heat transfer process in a two-phase region may increase the efficiency of the process.

As will be further understood by one of ordinary skill in the art, in a related concept heat transfer is proportional to, among other factors, the change in enthalpy. As illustrated in FIG. 5, in embodiments of the present disclosure, the enthalpy of the refrigerant entering the indoor heat exchanger 106 is reduced (from 160 to 158) by flowing through the in-line heat exchanger 114. Accordingly, by flowing refrigerant through the in-line heat exchanger 114, the change in enthalpy (i.e., between 158 and 164) is increased (over the change in enthalpy represented by 160 to 164). Thus, the amount of heat transfer from the indoor air to the refrigerant is also increased.

The above example was specific for a cooling cycle with reversing valve assembly 130 in a second position according to an embodiment of the present disclosure. According to an embodiment of the present disclosure, reversing valve assembly 130 may operate in a first position such that reversible heat pump refrigeration system operates to absorb heat at the outdoor heat exchanger 104 and reject heat to conditioned space 144, i.e., a heating mode. FIG. 3 is illustrative of a reversing valve assembly 130 in the first position. In the first position, the shuttle 142 fluidly couples first port 138 with the valve outlet 136 and fluidly couples compressor discharge 110 with second port 140. Accordingly, high pressure and high temperature refrigerant flows to the indoor heat exchanger 106 and rejects heat to the conditioned space 144.

After flowing through the indoor heat exchanger 106, refrigerant flows through the expansion device 108 and may flow through the in-line heat exchanger 114, entering at the second connection 118, and flow to the outdoor heat exchanger 104. The refrigerant flows to the reversing valve assembly in the first position (FIG. 3) and back to the compressor 102 through the valve exit 136. This configuration generally is a reverse of the refrigerant flow described above. Similarly, the flow may be represented by the chart 150 of FIG. 5 in the reverse order described above.

In some refrigeration loops 120 and with some refrigerants as the working fluid, system efficiency may be negatively impacted by flowing the refrigerant through the in-line heat exchanger 114 in the heating mode. Accordingly, the present disclosure provides an optional bypass fluid path 124 between first connection 116 and second connection 118 to divert the refrigerant flow from the in-line heat exchanger 114 during a heating mode. Included in the bypass fluid path 124 is a check valve 126 allowing a diverted flow in the heating mode only. In this regard, as the refrigerant leaves the expansion device 108 bypass fluid path 124 presents a path of lower resistance (e.g., may have a larger diameter) than the in-line heat exchanger 114. Flow would therefore be urged to travel from second connection 118 to first connection 116 rather than through the heat exchanger 114. The check valve 126 allows flow from second connection 118 to first connection and blocks flow from first connection 116 to second connection 118. Thus, in some embodiments, no refrigerant, or substantially no refrigerant, flows through the in-line heat exchanger 114 in the heating mode.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A reversible heat pump refrigeration system comprising:
a refrigeration loop comprising an outdoor heat exchanger and an indoor heat exchanger;
a valve body fluidly coupled to the refrigeration loop, the valve body comprising:
a valve inlet and a valve outlet; and
a first port and a second port;
a shuttle selectively movable in the valve body between a first position and a second position; and
a compressor having a suction side fluidly coupled to the valve outlet and a pressure side fluidly coupled to the valve inlet; and
wherein the valve outlet includes a heat exchanger having a first connection and a second connection.

2. The reversible heat pump refrigeration system of claim 1, wherein:
the outdoor heat exchanger is fluidly coupled to the refrigeration loop between the first port and the first connection; and
the indoor heat exchanger is fluidly coupled to the refrigeration loop between the second port and the second connection.

3. The reversible heat pump refrigeration system of claim 2, further comprising an expansion device fluidly coupled to the refrigeration loop between the second connection and the indoor heat exchanger.

4. The reversible heat pump refrigeration system of claim 3, wherein the expansion device is an electronic expansion valve.

5. The reversible heat pump refrigeration system of claim 1, wherein:
the shuttle in the first position fluidly couples the first port with the valve outlet and fluidly couples the valve inlet with the second port.

6. The reversible heat pump refrigeration system of claim 1, wherein:
the shuttle in the second position fluidly couples the valve outlet with the second port and fluidly couples the valve inlet with the first port.

7. The reversible heat pump refrigeration system of claim 1, further comprising a bypass fluid path between the first connection and the second connection.

8. The reversible heat pump refrigeration system of claim 7, further comprising a check valve in the bypass fluid path.

9. The reversible heat pump refrigeration system of claim 8, wherein:
the check valve blocks a fluid flow in the bypass fluid path from the first connection to the second connection; and
the check valve facilitates a fluid flow in the bypass fluid path from the second connection to the first connection.

10. The reversible heat pump refrigeration system of claim 1, wherein the heat exchanger is one of a tube-in-tube heat exchanger or a shell and coil heat exchanger.

11. A reversing valve assembly comprising:
a valve body comprising:
a valve inlet and a valve outlet; and
a first port and a second port;
a shuttle selectively movable in the valve body between a first position and a second position; and
wherein the valve outlet includes a heat exchanger having a first connection and a second connection.

12. The reversing valve assembly of claim 11, wherein:
the shuttle in the first position fluidly couples the first port with the valve outlet and fluidly couples the valve inlet with the second port.

13. The reversing valve assembly of claim 11, wherein:
the shuttle in the second position fluidly couples the valve outlet with the second port and fluidly couples the valve inlet with the first port.

14. The reversing valve assembly of claim 11, further comprising an expansion device fluidly coupled to the second connection.

15. The reversing valve assembly of claim 14, wherein the expansion device is an electronic expansion valve.

16. The reversing valve assembly of claim 14, further comprising a bypass fluid path between the first connection and the second connection.

17. The reversing valve assembly of claim 16, further comprising a check valve in the bypass fluid path.

18. The reversing valve assembly of claim 17, wherein:
the check valve blocks a fluid flow in the bypass fluid path from the first connection to the second connection; and
the check valve facilitates a fluid flow in the bypass fluid path from the second connection to the first connection.

19. The reversing valve assembly of claim 11, wherein the heat exchanger is a tube-in-tube heat exchanger.

20. The reversing valve assembly of claim 11, wherein the heat exchanger is a shell and coil heat exchanger.
